(19) United States
(12) Patent Application Publication
(10) Pub. No.: US 2004/0228292 A1
(43) Pub. Date: Nov. 18, 2004

(54) Method and apparatus for providing full duplex dispatch

(76) Inventor: David W. Edwards, Scottsdale, AZ (US)

Correspondence Address: MOTOROLA, INC., 1303 EAST ALGONQUIN ROAD, IL01/3RD, SCHAUMBURG, IL, 60196

(21) Appl. No.: 10/435,820

(22) Filed: May 12, 2003

(51) Int. Cl. H04B 7/00

(52) U.S. Cl. 370/277

(57) ABSTRACT

A method for providing full duplex dispatch operation includes the step of establishing a dispatch call (102) and determining if a full duplex dispatch mode is desired (104). If full duplex dispatch operation is selected, a signal is sent to the communication system requesting that full duplex dispatch operation is requested. The communication system then provides the necessary channel resources to allow for full duplex dispatch operation (106). In another embodiment, the radio user can select full duplex dispatch mode (202) prior to call setup. A radio (310) capable of providing both half duplex and full duplex dispatch operation is also described.

### TECHNICAL FIELD

This invention relates in general to the field of wireless communications, and more specifically to a method and apparatus for providing full duplex dispatch mode of operation.

### BACKGROUND

In an effort to support the increasing demands on wireless communications, a wireless communication system such as the Integrated Digital Enhanced Network (iDEN®) wireless communication system manufactured by Motorola, Inc. provides an integration of traditional Push-To-Talk (PTT), half-duplex, radio technology also known as dispatch, and full-duplex cellular communications also known as interconnect calling.

In the (iDEN®) wireless communication system as an example, a PTT or dispatch call splits a single 25 Kilo-Hertz (25 KHz) carrier into six channels. During a dispatch call, one channel on the carrier is used. This channel is used and allocated for the duration of the conversation (e.g., until everybody hangs-up or times-out). During a dispatch call, the two or more participants involved operate in a half-duplex mode whereby the participants are either speaking or listening at any one time. Dispatch calls in an iDEN® communication system allow for one user to immediately connect with another user or a group of users (e.g., a private dispatch or group dispatch call) and have a private conversation with the press of one button. However, with dispatch communications each of the users has to depress the PTT switch on his/her radio to transmit a message to the other dispatch call participants given the half-duplex nature of the communications.

Interconnect calls, unlike dispatch calls, are full duplex communications where each of the call participants can talk and listen at the same time, similar to a standard telephone call. The advantages of interconnect calls are obvious, since unlike dispatch calls, a user can talk and listen at the same time. However, interconnect calls do not allow for instant connection with one or more other users as can be done when using dispatch. Given the above, a need exists for a method and apparatus that can provide for full duplex dispatch calls thus, providing for the quick connect capability of dispatch calls while providing for the benefits of full duplex operation.

### BRIEF DESCRIPTION OF THE DRAWINGS

The features of the present invention, which are believed to be novel, are set forth with particularity in the appended claims. The invention may best be understood by reference to the following description, taken in conjunction with the accompanying drawings, in the several figures of which like reference numerals identify like elements, and in which:

FIG. 1 shows a flowchart highlighting the steps taken in accordance with one embodiment of the invention.

FIG. 2 shows another flowchart highlighting the steps taken in accordance with another embodiment of the invention.

FIG. 3 shows a diagram of a communication system in accordance with an embodiment of the invention.

FIG. 4 shows a block diagram of a radio in accordance with an embodiment of the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures.

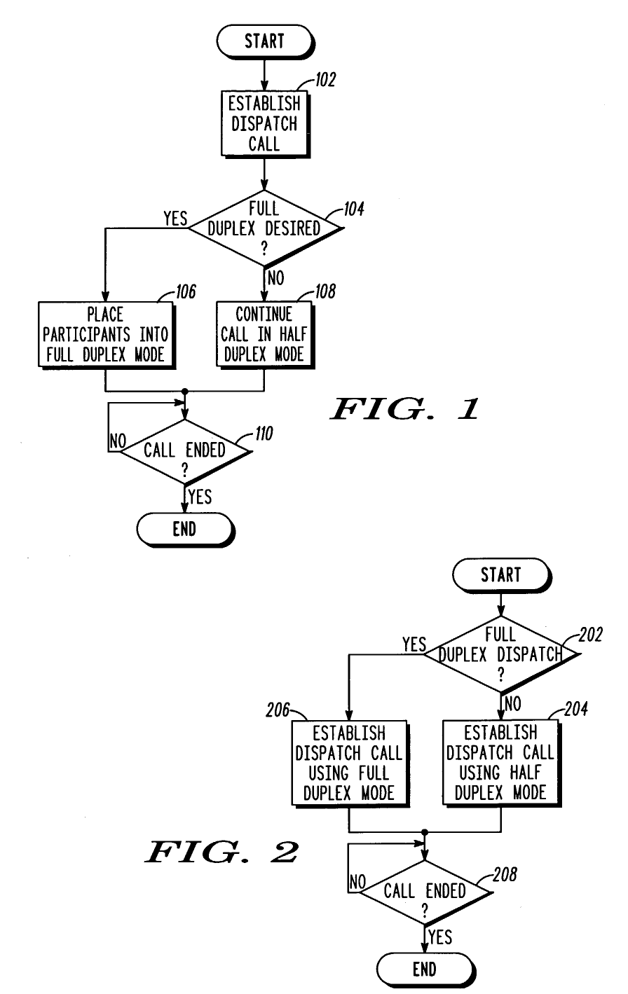

Referring now to FIG. 1, there is shown a flowchart highlighting the steps taken in accordance with an embodiment of the invention. In step 102, a wireless radio user establishes a half-duplex dispatch call with one or more other users. In decision step 104, it is determined if the user who established the dispatch call wants to use a full duplex dispatch mode. If he does not, in step 108, the dispatch call continues as normal in a half-duplex mode. If however, in step 104, the user who established the call wants to use the full-duplex mode of operation for the dispatch call, he requests this mode by pressing one or more keys or a menu button in the communication device. In response to the full-duplex selection, a signal is sent to the system controller requesting that the system establish a full duplex dispatch communication call.

Depending on the particular communication system involved, the system controller in response to receiving the full duplex dispatch call request will provide the necessary channel resources to support a full duplex call. For example, if the communication system has cellular capabilities as well as dispatch capabilities as the iDEN® system has, the system controller may assign a conventional cellular traffic channel to the call that can support full duplex operation (e.g, a cellular channel like a Carrier Division Multiple Access (CDMA channel) which provides for full duplex communications). In an analog system, the system controller may assign a second channel to the call, thereby allowing for full duplex communications between the call participants (e.g., one channel providing half duplex operation in one direction and the other channel providing half duplex operation in the other direction, thereby allowing for full duplex operation capability).

In step 106, the one or more other users who are participating in the dispatch call are placed in the full duplex mode of operation by the communication system. If one of the radios involved in the dispatch call is not capable of being automatically placed in a full duplex mode of operation (e.g., older radio not having the capability of this invention, etc.), it may continue in the dispatch call, however the user will need to depress his PTT key to transmit as is normal in a half-duplex mode.

In other embodiments of the invention, in step 106, each radio participating in the dispatch call can make the determination if it wants to switch to full duplex mode or continue to use a half duplex mode of operation. In this scenario, each radio involved in the original dispatch call may receive a distinct audio and/or visual alert indicating to the user that the originator of the dispatch call wants to go to full duplex operation. In this scenario, if any radio involved in the dispatch call decides to remain in the half duplex mode, all of the other radios operating in full duplex mode must wait for the radios operating in half duplex mode to stop talking (transmitting) before commencing to speak. In still another embodiment, in step 104 any user involved in the dispatch call (not only the originator of the dispatch call) can make the request for full dispatch mode of operation.

Once the dispatch call has been established, the participants involved in the dispatch call can end the call in step 110 by a user key or menu item in their communication device. If the dispatch call is a group dispatch call that includes more than two radio communication devices, one communication device terminating its involvement in the dispatch call does not necessarily mean that the entire dispatch call is ended. Criteria for terminating a full duplex dispatch call can be determined based on the design requirements for the particular system.

In FIG. 2, there is shown a flowchart highlighting another embodiment of the invention. In this embodiment, a user can decide in step 202 prior to commencing a dispatch call if a full duplex mode is desired. If full duplex dispatch is not desired, in step 204 the dispatch call whether a private or group dispatch call is performed using the standard half-duplex mode. If however, full duplex dispatch is requested in step 202, for example by the radio user activating a key or menu item, in step 206, the communication system establishes the dispatch call using full duplex mode of operation for all of the dispatch call participants. In decision step 208 it is determined if the dispatch call has ended. A dispatch call is ended in the case of a private dispatch call between two communication devices when one of the call participants activates a call termination switch or menu item in his/her communication device. Alternatively, a dispatch call may be terminated if one of the communication devices involved in the dispatch call leaves the coverage area of the communication system.

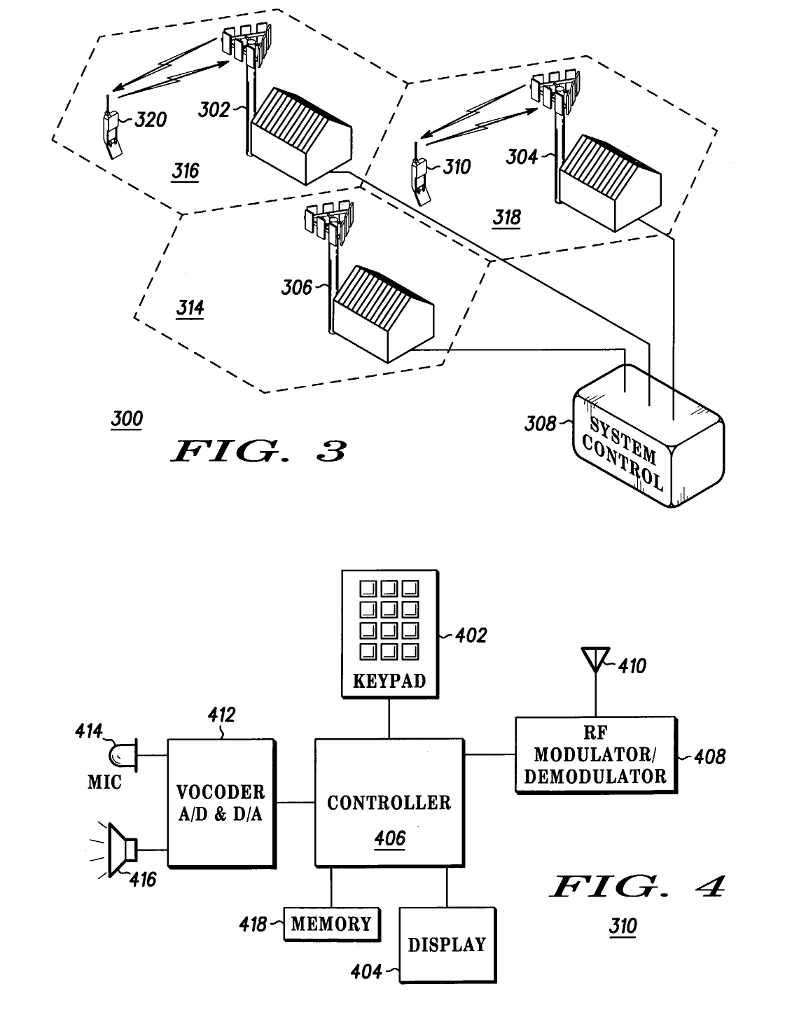

In FIG. 3 there is shown a communication system 300 in accordance with one embodiment of the invention. Communication system 300 can comprise an iDEN® communication system that has been modified to provide for both half-duplex and full-duplex dispatch communication capability in accordance with the invention. Communication system 300 can also comprise any other type of wireless communication system that provides for dispatch communications.

Communication system 300 includes a plurality of base stations or cell sites 302-306. Each cell site provides the radio frequency link between the land network and the wireless communication devices or Mobile Stations (MSs) 310 and 320. Each cell site 302, 304 and 306 provides communication coverage over their respective cell coverage areas 316, 318 and 314. A system control 308 provides the needed coordination between the cell sites 302-306, the landline network (e.g., Public Switched Telephone Network, Internet, etc.) (not shown), and MSs 310 and 320 operating within the wireless communication system. System control 308 includes all of the necessary infrastructure components as is typically found in a communication system such as the iDEN® communication system. Per the present invention, if communication device 310 wants to establish a dispatch call with second communication device 320, it sends a request to the system control 308, which in response to a request for a full duplex dispatch channel assigns the necessary system resources to support the full duplex dispatch call.

Referring now to FIG. 4, there is shown a simplified block diagram of MS 310 (or MS 320). MS 310 includes a controller 406 such as a microprocessor and/or digital signal processor that controls the overall function and operation of the MS 310. A keypad 402 and display 404 are coupled to the controller 406 and allow for user interface with MS 310. A microphone 414 is provided for converting voice from the user into electrical signals, while a speaker 416 provides audio signals to the user.

A vocoder, Analog-to-Digital (A/D) and Digital-to-Analog (D/A) block 412 provides all the necessary digital voice processing for converting analog voice into digital data ready for RF transmission and vice versa. Preferably the vocoder in block 412 comprises a Selective Multirate (SMV) vocoder that is used for both dispatch and interconnect calls, which will allow for bearer path compatibility between half and full duplex operation in accordance with one embodiment of the invention. RF modulator/demodulator (transmitter/receiver) block 408 transmits and receives the RF signals via antenna 410. A memory 418 such as Random Access Memory (RAM) and/or Read Only Memory (ROM) coupled to controller 406 stores the necessary instructions and information for controller 406. Stored in memory 418 in accordance with one embodiment of the invention, are identification numbers for other communication devices that communication device 310 can establish half and/or full duplex dispatch communications with.

The user of communication device 310 can select a particular communication device to have a private dispatch call with or a group of radios to have a group dispatch call with using keypad 402 or a PTT switch located on keypad 402 or somewhere else on the housing of communication device 310. The communication device 310 can be preprogrammed such that a key press of the PTT button or other user control on the device 310 automatically establishes full duplex communications with one or more other communication devices.

The present invention allows for the benefits of the quick call set-up (“Direct Connect”) provided by a dispatch call, while allowing the users the advantages of full duplex operation if desired. The present invention can be used with any type of wireless communication system having a PTT feature that has unused or assignable channel assets. Given the need for the added system resources, the full duplex dispatch mode of operation of the present invention, may be considered a premium service and the system service provider may be able to charge additional for this service, or provide this as a marketing advantage.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for providing full duplex dispatch operation in a wireless communication device that can operate in both half duplex and full duplex dispatch modes in a wireless communication system, the method comprising the steps of:
(a) transmitting a request from the wireless communication device that a half duplex dispatch call be established between the wireless communication device and at least one other wireless communication device; and
(b) transmitting a request from the wireless communication device to the wireless communication system requesting that the half duplex dispatch call established in step (a) be changed to a full duplex dispatch call.

2. A method as defined in claim 1, wherein the wireless communication device communicates with the at least one other wireless communication device in a full duplex dispatch mode using two half duplex communication channels.

3. A method as defined in claim 1, wherein the wireless communication device communicates with the at least one other wireless communication device in a full duplex dispatch mode using a communication channel capable of supporting full duplex communications.

4. A method as defined in claim 3, wherein the communication channel comprises a Code Division Multiple Access (CDMA) communication channel.

5. A method for providing dispatch operation between a first communication device and a second communication device operating in a wireless communication system that supports both half duplex and full duplex dispatch operation, the method at the first communication device comprising the steps of:
(a) determining if a dispatch call is to be established in a half duplex or full duplex mode; and
(b) sending a request from the first communication device to the wireless communication system for the establishment of a full duplex dispatch call between the first and second communication devices if in step (a) it is determined by the first communication device that the dispatch call is to be established in a full duplex mode.

6. A method as defined in claim 5, wherein step (b) is performed automatically by a user control being activated in the first communication device.

7. A method for providing full duplex dispatch operation in a wireless communication system, comprising the steps of:
(a) establishing a dispatch call between at least two communication devices;
(b) sending a signal to the wireless communication system by one of the at least two communication devices if full duplex dispatch operation is requested; and
(c) placing the at least two communication devices in a full duplex dispatch mode in response to the signal being sent in step (b).

8. A method as defined in claim 7, wherein step (a) is performed by one of the at least two communication devices, and the dispatch call is established in step (a) in a half duplex mode.

9. A method as defined in claim 7, wherein step (b) is performed by the communication device from among the at least two communication devices that established the dispatch call in step (a).

10. A method as defined in claim 9, wherein if full duplex operation is not desired, the signal requesting full duplex dispatch operation is not sent in step (b) and the at least two communication device continue their dispatch call in a half duplex mode.

11. A method as defined in claim 7, wherein in step (c) the wireless communication system provides the necessary system resources to allow the at least two communication devices to operate in a full duplex mode while in the dispatch call.

12. A method as defined in claim 11, wherein the wireless communication system sends a signal to at least one of the at least two communication devices informing it that it is being placed in a full duplex mode.

13. A method for providing full duplex dispatch operation between first and second communication devices in a wireless communication system that provides for both half duplex and full duplex dispatch operation, the method comprising the steps of:
a. determining at the first communication device if a dispatch call is to be made in either a half duplex mode or in a full duplex mode; and
b. establishing a dispatch call between the first and the second communication devices in the full duplex mode of operation if in step (a) it is determined that the full duplex mode of operation is to be used.

14. A method as defined in claim 13, wherein in step (b) the second communication device receives a signal from the wireless communication system informing it if it wants to participate in the full duplex mode.

15. A method as defined in claim 14, wherein the signal sent to the second communication device causes an audio and/or visual alert to be provided at the second communication device.

16. A method as defined in claim 13, wherein in step (a) the determination is made automatically by the first communication device that the dispatch call is to be made in the full duplex mode if the first communication device has been preprogrammed for this automatic selection.

17. A method as defined in claim 16, wherein the automatic selection of the full duplex mode is made if the identification of the second communication device is in a list of communication device identifications stored in the first communication device.

18. A method as defined in claim 13, further comprising the step of:
(c) terminating the full duplex dispatch call between the first and second communication devices if either of the first or second communication devices actively terminates the full duplex dispatch call in response to a user control at either the first or second communication device being activated.

19. A radio communication device, comprising:
a transmitter;
a receiver; and
a controller coupled to the transmitter and receiver, the controller placing the radio communication device in either a half duplex dispatch mode or a full duplex dispatch mode.

20. A radio communication device as defined in claim 19, wherein the controller places the radio communication device in either the half duplex or full duplex dispatch mode in response to a dispatch selection signal received at the receiver.

21. A radio communication device as defined in claim 20, further comprising:
a. a memory coupled to the controller, the memory storing therein the identification of at least a second radio communication device that the radio communication device can automatically establish a full dispatch communication with.

22. A radio communication device as defined in claim 21, further comprising:
a user interface coupled to the controller; and
the radio communication device can automatically establish full duplex dispatch communications with the second radio communication by the user interface being activated.

23. A radio communication device as defined in claim 19, wherein if a signal is received at the receiver indicating that a second radio communication wants to establish full duplex dispatch communications with the radio communication device, a visual and/or audio signal is generated at the radio communication device.
